(19) United States
(12) Patent Application Publication
(10) Pub. No.: US 2020/0323245 A1
(43) Pub. Date: Oct. 15, 2020

(54) CONTROLLING TEMPERATURE AND HUMIDITY IN A FOOD TRANSPORTATION SYSTEM

(71) Applicant: FISHSIX RC THE MELT, San Francisco, CA (US)

(72) Inventors: Anthony LE, San Francisco, CA (US); Jaih HUNTER-HILL, Mountain View, CA (US); Ryan FERNANDEZ, San Francisco, CA (US); Ralph BOWER, Scottsdale, AZ (US)

(21) Appl. No.: 16/847,536

(22) Filed: Apr. 13, 2020

Related U.S. Application Data
(60) Provisional application No. 62/834,231, filed on Apr. 15, 2019.

(51) Int. Cl. A23L 3/3418; B65D 81/18; A23L 3/00

(52) U.S. Cl. CPC A23L 3/3418; A23V 2002/00; A23L 3/001; B65D 81/18

(57) ABSTRACT

A food transportation system may include a box with a cavity, sensors including a temperature sensor and a humidity sensor, one or more temperature manipulation elements, one or more humidity manipulation elements, memory, and a processor is coupled to the memory. When executing one or more instructions stored in the memory, the processor is configured to monitor a temperature within the cavity via the temperature sensor; determine, based on data from the temperature sensor, whether the temperature within the cavity meets a temperature setpoint; control the temperature within the cavity via the temperature manipulation elements to meet the temperature setpoint; monitor a humidity within the cavity via the humidity sensor; determine, based on data from the humidity sensor, whether the humidity within the cavity meets a humidity setpoint; and control the humidity within the cavity via the humidity manipulation elements to meet the humidity setpoint.

### CROSS-REFERENCE TO RELATED APPLICATIONS

This application claims the benefit of the U.S. Provisional Application titled “CONTROLLING TEMPERATURE AND HUMIDITY IN A FOOD TRANSPORTATION SYSTEM”, filed on Apr. 15, 2019, and having Application No. 62/834,231, the subject matter of which is hereby incorporated by reference in its entirety.

### BACKGROUND

### Field of the Various Embodiments

The present disclosure relates generally to transportation of food, and more specifically, to controlling temperature and humidity in a food transportation system.

### Description of the Related Art

Food delivery is a longstanding service offered by restaurants and other prepared food businesses. Food delivery allows a customer who wishes to refrain from dining in or cooking for whatever reason to still enjoy prepared food offerings. Technology has augmented food delivery service even further and opened up new opportunities by enabling features such as online ordering.

One constant concern in prepared food delivery services is the maintenance of food quality from door to door, from restaurant to customer. Maintenance of food quality characteristics, such as temperature and texture, are critical to the enjoyment of the food by customers, and by extension are critical to the maintenance of the reputation and business of a restaurant or food preparation service.

Conventional techniques for maintaining food quality during transport to the customer include putting the food in an insulated environment (e.g., pizzas delivered in an insulated bag). A drawback of this approach is that the insulated environment, at best, merely slows the rate of decrease of the temperature of the food. With the temperature still decreasing, the temperature may decrease to a level below a minimum temperature for enjoyment of the food. When the food temperature drops below the minimum enjoyment temperature, the customer may have to reheat the food, which can negatively affect the quality of the food as well as being an inconvenience for the customer. The temperature may also decrease to a level below a minimum temperature for food safety. Other approaches include placing the food in a temperature-controlled box. While this approach addresses some of the drawbacks of the insulated environment, this approach still does not guarantee the best food quality upon delivery. For example, one drawback of both the insulated environment and temperature-controlled box is that humidity within the environment or box is not regulated. Food textures, which often are sensitive to humidity, may be negatively affected by the unregulated humidity.

Accordingly, improved food transportation systems and techniques are desirable.

### SUMMARY

One or more embodiments set forth a food transportation system comprising a box comprising a cavity; a plurality of sensors, the plurality of sensors comprising a temperature sensor and a humidity sensor; one or more temperature manipulation elements; one or more humidity manipulation elements; memory; and a processor that is coupled to the memory. When executing one or more instructions stored in the memory, the processor is configured to monitor a temperature within the cavity via the temperature sensor; determine, based on data from the temperature sensor, whether the temperature within the cavity meets a temperature setpoint; control the temperature within the cavity via the one or more temperature manipulation elements to meet the temperature setpoint; monitor a humidity within the cavity via the humidity sensor; determine, based on data from the humidity sensor, whether the humidity within the cavity meets a humidity setpoint; and control the humidity within the cavity via the one or more humidity manipulation elements to meet the humidity setpoint.

One or more embodiments set forth a container for transporting food comprising a cavity; a plurality of sensors, the plurality of sensors comprising a temperature sensor and a humidity sensor; one or more temperature manipulation elements; one or more humidity manipulation elements; memory; and a processor that is coupled to the memory. When executing one or more instructions stored in the memory, the processor is configured to monitor a temperature within the cavity via the temperature sensor; determine, based on data from the temperature sensor, whether the temperature within the cavity meets a temperature setpoint; control the temperature within the cavity via the one or more temperature manipulation elements to meet the temperature setpoint; monitor a humidity within the cavity via the humidity sensor; determine, based on data from the humidity sensor, whether the humidity within the cavity meets a humidity setpoint; and control the humidity within the cavity via the one or more humidity manipulation elements to meet the humidity setpoint.

One or more embodiments set forth a computer-implemented method for maintaining food quality during transportation comprising monitoring a temperature within a cavity of a container via a temperature sensor; determine, based on data from the temperature sensor, whether the temperature within the cavity meets a temperature setpoint; control the temperature within the cavity via one or more temperature manipulation elements to meet the temperature setpoint; monitor a humidity within the cavity via a humidity sensor; determine, based on data from the humidity sensor, whether the humidity within the cavity meets a humidity setpoint; and control the humidity within the cavity via one or more humidity manipulation elements to meet the humidity setpoint.

At least one advantage and technological improvement of the disclosed techniques is that both temperature and humidity are actively controlled and maintained within an environment in which food is held for transportation. Accordingly, food quality can be better preserved door-to-door in comparison to conventional techniques.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1A illustrates an exploded view of a food transportation box of a food transportation system, in accordance with various embodiments;

FIG. 1B illustrates an exploded view of a lid of the food transportation box of FIG. 1A, in accordance with various embodiments;

FIG. 1C illustrates a perspective view of the food transportation box of FIG. 1A, in accordance with various embodiments;

FIG. 2 illustrates an example cavity of a food transportation box of the food transportation system, in accordance with various embodiments;

FIG. 3 illustrates a computing system of the food transportation system, in accordance with various embodiments; and

FIG. 4 illustrates a flow diagram showing method steps for controlling a food transportation environment, in accordance with various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

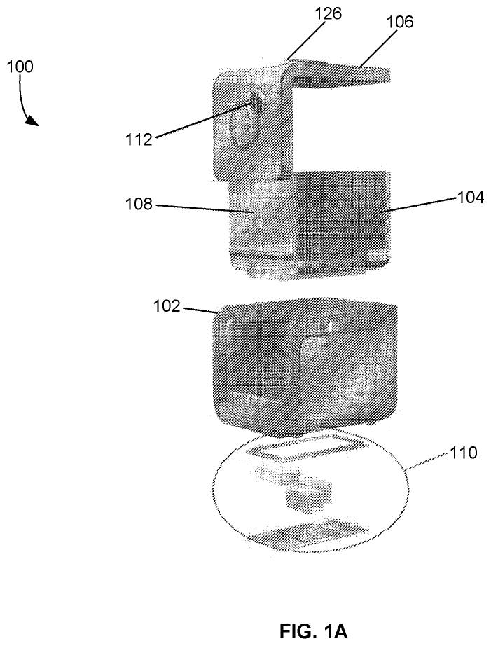

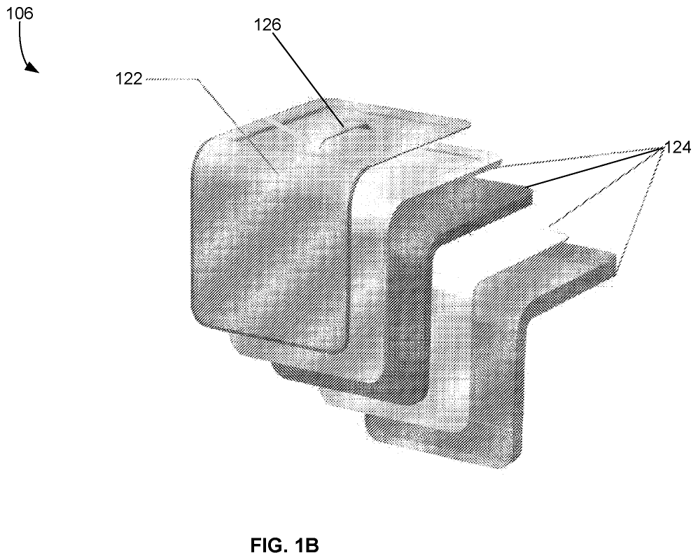

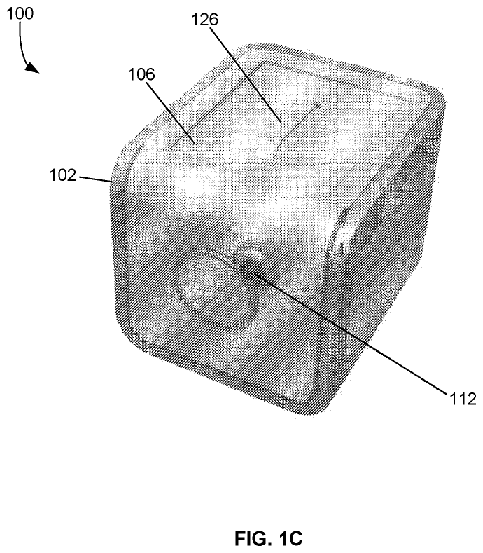

FIG. 1A illustrates an exploded view of a food transportation box of a food transportation system, in accordance with various embodiments. In various embodiments, a food transportation system includes a food transportation box or container 100. Food transportation box 100 is configured to hold food in an environment where temperature and humidity is controlled and maintained throughout transportation of the food from a source location (e.g., a restaurant where the food is prepared) to a destination location (e.g., a customer location), in order to maintain food quality upon delivery of the food to the destination location. Food transportation box 100 is sized to be portable by a user (e.g., a food delivery person). It should be appreciated that while food transportation box 100, as shown, has a substantially rectangular shape, food transportation box 100 may have any suitable shape (e.g., a cylindrical shape, a dome shape, etc.). As shown, food transportation box 100 includes an outer shell 102, an inner shell 104, a lid 106, a cavity 108, a computing system 110, and a user interface 112.

Outer shell 102 may provide structure and protection, as well as an aesthetic appearance, to food transportation box 100. Outer shell 102 may serve as the chassis for food transportation box 100. In various embodiments, outer shell 102 may include a flexible polymer material (e.g., a nylon fabric) to provide protection from usage, handling, and the elements (e.g., abrasion protection). Outer shell 102 may further include a frame or other structure constructed of a rigid material (e.g., a metal) to provide structural rigidity (e.g., so that multiple boxes 100 may be stacked for storage) and additional protection (e.g., impact protection). More generally, outer shell 102 may be constructed from any technically feasible material that is suitable for providing at least one of protection or structural rigidity to food transportation box 100. Outer shell 102 further includes an opening that, along with an opening of inner shell 104, leads into cavity 108.

Outer shell 102 may include one or more vent openings to the exterior to facilitate airflow between the exterior and cavity 108 via vent openings and/or channels in inner shell 104. Additionally, outer shell 102 may include a base or one or more compartments for housing various components of computing system 110 and other associated components (e.g., electronics, humidifier, dehumidifier). In some embodiments, a water chamber may be housed in outer shell 102 (e.g., in the base or in a side wall). The water chamber may be opened to the exterior for refilling by a user. Additionally, outer shell 102 may include one or more plug-in sockets of various formats. The plug-in sockets may facilitate electrically and/or communicatively coupling, via wire or cable, of computing system 110 to a power source, a client device, and so forth.

In some embodiments, outer shell 102 serves as a further layer of thermal insulation for inner shell 104 and cavity 108. Accordingly, outer shell 102 may include an insulative material.

Inner shell 104 provides insulation for cavity 108 of food transportation box 100. Inner shell 104 is configured to fit the inside of outer shell 102, and the inner wall of inner shell 104 lines cavity 108. Inner shell 104 may include one or more layers of thermal insulation in order to minimize heat loss from cavity 108. In some embodiments, inner shell 104 includes a first layer of silicone or fiberglass insulation and a second layer of nitrile rubber (also called “NBR rubber”). More generally, inner shell 104 may be constructed from any technically feasible material that is suitable for providing thermal insulation, and optionally at least one of protection, structural definition, or structural rigidity, to cavity 108.

In various embodiments, inner shell 104 may include one or more slots on the inner wall of inner shell 104 lining cavity 108. Removable racks and/or dividers may be mounted within cavity 108 via the slots (e.g., sliding the racks or dividers into the slots). Further, in some embodiments, the racks and/or dividers may be fixed within inner shell 104 and not removable.

In various embodiments, inner shell 104 includes one or more vent openings and/or channels that couple to vent openings on outer shell 102. The vent openings and/or channels in inner shell 104 facilitate air flow between the exterior and cavity 108. Additionally, various temperature and/or humidity control components may be mounted on or in inner shell 104. For example, at least one of one or more sensors, one or more fans, one or more heating elements, and one or more humidity control system components may be mounted on the inner wall of inner shell 104 (thus facing cavity 108) or in inner shell 104. Inner shell 104 may further couple electronic components (e.g., wiring, terminals, etc.) for electronically and/or communicatively coupling the temperature and/or humidity control components to computing system 110.

Lid 106 provides access to cavity 108 when in an opened position or removed, and provides cover from the exterior for cavity 108 when in a closed position. In some embodiments, as shown in FIG. 1A, lid 106 is L-shaped and can expose cavity 108 on two sides of food transportation box 100. In some other embodiments, lid 106 is a substantially flat piece or panel (e.g., like a door) that can expose cavity 108 on one side of food transportation box 100. Lid 106 may include at least some of the same layers that form outer shell 102 and/or inner shell 104. A layered construction of lid 106 is illustrated in FIG. 1B and further described below in conjunction with FIG. 1B.

Lid 106 may be fixably or removably attached to food transportation box 100. For example, in some embodiments, the outer layer portion of lid 106 is continuous with the outer layer portion of outer shell 102 (e.g., the outer layer portions of lid 106 and outer shell 102 are formed from one piece of material), and the outer layer material is flexible to allow for opening and closing of lid 106. Accordingly, in these embodiments lid 106 is fixably attached to, and not removable from, food transportation box 100. In some other embodiments, lid 106 may be fixably attached to outer shell 102 via a hinge mechanism. In some further embodiments, lid 106 may be completely removable from food transportation box 100. Whether lid 106 is fixably or removably attached to food transportation box 100, a lid 106 in the closed position may be secured to food transportation box 100 via any technically feasible mechanism (e.g., a zipper, a key lock, a catch lock, a latch, a magnetic catch, etc.).

Lid 106 may include a gasket along its inner wall facing inner shell 104 and cavity 108. The gasket may be positioned and configured to contact inner shell 104 when lid 106 is in the closed position, in order to form a seal along inner shell 104. The gasket may be made of any suitable material (e.g., rubber, silicone), and in various embodiments the material that forms the gasket is a thermally insulating and/or waterproof material.

Lid 106 may include a handle 126. When lid 106 is in the closed position and secured to food transportation box 100, a user may lift and carry food transportation box 100 via the handle.

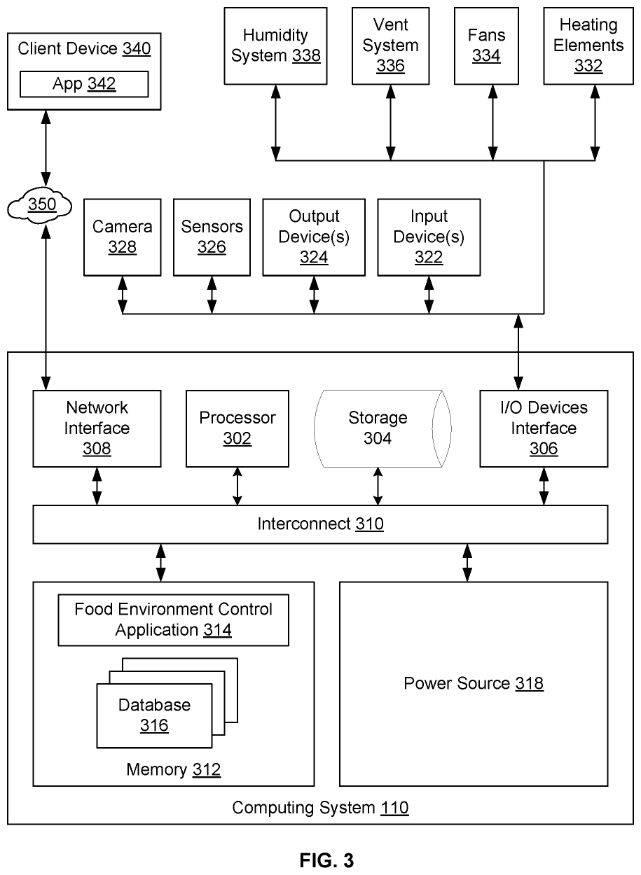

Food transportation box 100 further includes a computing system 110. Computing system 110 is configured to monitor multiple parameters of cavity 108 (e.g., temperature, humidity, etc.) via sensors installed on inner shell 104. Based on the data from the sensors, computing system 110 may control one or more elements to manipulate the parameters to meet certain setpoints or thresholds. The elements may include one or more temperature manipulation elements (e.g., heating element(s), fan(s), a vent system) and/or one or more humidity manipulation elements (e.g., fan(s), the vent system, a humidity system). Various components of computing system 110 may be housed in outer shell 102 (e.g., in a base of outer shell 102) and/or inner shell 104 Computing system 110 is further described below in conjunction with FIG. 3.

Food transportation box 100 also includes a user interface 112. In some embodiments, user interface 112 may include one or more input devices (e.g., buttons, dials, image scanner, etc.) and one or more output devices (e.g., display device(s)). The input devices and output devices may be located on lid 106 and/or outer shell 102, and are exterior-facing and accessible by a user of food transportation box 100, such as when lid 106 is closed. As shown in FIG. 1A, user interface 112 is located on lid 106. The input devices and output devices may be electronically and communicatively coupled to computing system 110 (e.g., via electrical leads in lid 106 that lead to electrical leads in inner shell 104 and outer shell 102). The user may make inputs to computing system 110 via the input devices and obtain information output by computing system 110 via the output devices. Additionally or alternatively, user interface 112 of food transportation box 100 may be provided via a client device (e.g., a smartphone, a tablet computer, a laptop computer, a desktop computer) communicatively coupled to food transportation box 100.

Food transportation box 100 includes sensors configured to monitor various parameters within cavity 108 while food is being held in cavity 108 for transport. In various embodiments, the sensors include at least a temperature sensor and a humidity sensor for monitoring the temperature and humidity, respectively, of cavity 108. In some embodiments, the sensors include multiple temperature sensors and/or multiple humidity sensors for monitoring the temperature and humidity, respectively, of different regions of cavity 108 (e.g., top half and bottom half regions, right half and left half regions, four quadrant regions, etc.). In some embodiments, sensors include sensors for monitoring other parameters (e.g., oxygen level, carbon dioxide level) of cavity 108 that may affect food quality.

FIG. 1B illustrates an exploded view of lid 106 of food transportation box 100, in accordance with various embodiments. Lid 106 includes an outer layer 122, which include a lid 106. Outer layer 122 may be constructed of a same material as an outer layer of outer shell 102. Lid 106 also includes one or more inner layers 124. Inner layers 124 may include the same layers as inner shell 104. For example, inner layers 124 may include one or more layers of insulation.

FIG. 1C illustrates a perspective view of food transportation box 100, in accordance with various embodiments. As shown, lid 106 is in a closed position and secured to outer shell 102. While lid 106 is secured to outer shell 102, a user may carry food transportation box 100 via handle 126. Lid 106 includes user interface 112 that is exterior-facing and accessible by a user.

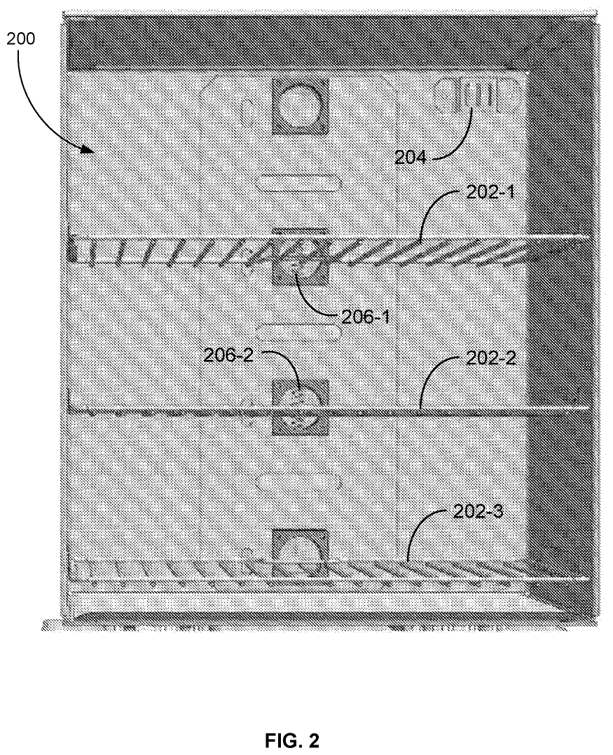

FIG. 2 illustrates an example cavity of a food transportation box of the food transportation system, in accordance with various embodiments. Cavity 200 (e.g., cavity 108) may be defined by the inner wall of inner shell 104. One or more racks 202 may be mounted in cavity 108 to provide multiple regions for holding food. Racks 202 hold food in three regions of cavity 200—rack 202-1 holds food in a top region, rack 202-2 holds food in a middle region, and rack 202-3 holds food in a bottom region. And although cavity 200 is shown with three regions, other configurations of cavity 200 are possible where cavity 200 includes one, two, four, five, or more regions.

Cavity 200 may include a number of heating elements 206. As shown, heating element 206-1 is positioned at the same height as rack 202-1, and heating element 206-2 is positioned at the same height as rack 202-2. Cavity 200 may further include a vent 204. In some embodiments, vent 204 is a passive vent—air flows freely in or out of cavity 200 through vent 204. In some other embodiments, vent 204 may include a shutter that is controllable by computing system 110—computing system 110 may open or close the shutter to allow or restrict airflow through vent 204. In addition or alternative to a shutter, a fan may be mounted in proximity of vent 204 (e.g., in inner shell 104 behind vent 204). The fan may be controlled by computing system 110 to actively induce air flow in or out of cavity 200 via vent 204 and/or throughout cavity 200. In some embodiments, cavity 200 may optionally include one or more pieces of material (not shown) that help direct air throughout cavity 200 and across food held within cavity 200. These pieces of material (e.g., airflow diverters) may be aerodynamically shaped (e.g., shaped as a diamond shape, as a triangular wedge, with a curve, etc.) to direct airflow to certain regions in cavity 200. These pieces of material may be installed on the wall of cavity 200 and/or on any of the racks 202.

FIG. 3 illustrates computing system 110 of the food transportation system, in accordance with various embodiments. Computing system 110 may monitor cavity 108 and control various elements to maintain certain levels for parameters associated with cavity 108. As shown, computing system 110 includes, without limitation, one or more processors 302, storage 304, I/O device interface 306, (optional) network interface 308, interconnect 310, memory 312, and power source 318. Processor(s) 302 and memory 312 may be implemented in any technically feasible fashion. For example, and without limitation, in various embodiments, any combination of the processor 302 and the memory 312 may be implemented as a stand-alone chip or as part of a more comprehensive solution that is implemented as an application-specific integrated circuit (ASIC), a system-on-a-chip (SoC), and/or the like. Processor(s) 302, I/O device interface 306, network interface 308, storage 304, and memory 312 may be communicatively coupled to each other via interconnect 310. Computing system 110 as a whole may be powered by power source 318, which may deliver power to the various components of computing system 110 via interconnect 310.

The one or more processors 302 may include any suitable processor, such as a central processing unit (CPU), an application-specific integrated circuit (ASIC), a field programmable gate array (FPGA), any other type of processing unit, or a combination of multiple processing units. In general, each of the one or more processors 302 may be any technically feasible hardware unit capable of processing data and/or executing software applications and modules.

Storage 304 may include non-volatile storage for applications, software modules, and data, and may include fixed or removable disk drives, flash memory devices, solid state disk drives, or other magnetic, optical, solid state storage devices, and/or the like.

Memory 312 may include a random access memory (RAM) module, a flash memory unit, or any other type of memory unit or combination thereof. The one or more processors 302, I/O device interface 306, and network interface 308 are configured to read data from and write data to memory 312. Memory 312 includes various software programs and modules (e.g., an operating system, one or more applications) that can be executed by processor(s) 302 and application data (e.g., data loaded from storage 304) associated with said software programs.

In some embodiments, computing system 110 is communicatively coupled to one or more networks 350. Network 350 may be any technically feasible type of communications network that allows data to be exchanged between computing system 110 and remote systems or devices, such as a client device 340, a server, a cloud computing system, or other networked computing device or system. For example, network 350 may include a wide area network (WAN), a local area network (LAN), a wireless network (e.g., a Wi-Fi network, a cellular data network, an ad-hoc Bluetooth connection), and/or the Internet, among others. Computing system 110 may connect with network(s) 350 via network interface 308. In some embodiments, network interface 308 is hardware, software, or a combination of hardware and software, that is configured to connect to and interface with network(s) 350.

Computing system 110 may be coupled, via I/O devices interface 306, to one or more input devices 322, one or more output devices 324, sensors 326, and optionally a camera 328. I/O devices interface 306 may include any number of interfaces for coupling communicatively with input/output devices and other accessories, peripherals, or devices. I/O devices interface 306 may include, for example, a Universal Serial Bus (USB) interface. Input devices 322 may include devices capable of receiving inputs into computing system 110. Examples of input devices 322 include, without limitation, buttons, knobs, dials, sliders, touch-sensitive surfaces (e.g., touchpad, touch-sensitive screen), a keypad, a code scanner (e.g., for scanning codes, such as barcodes or QR codes, on a receipt associated with the food), a microphone, and/or the like.

Output devices 324 may include devices capable of providing output to a user of food transportation box 100. Examples of output devices 324 include, without limitation, a LCD display, a LED display, a touch-sensitive screens, and a digital readout display. In some embodiments, output devices 324 further include an audio output device (e.g., a speaker).

Sensors 326 measure and/or collect data regarding various parameters in cavity 108 and transmit the data back to computing system 110. Sensors 326 include one or more temperature sensors, one or more humidity sensors, and optionally one or more other sensors (e.g., oxygen sensors, carbon dioxide sensors). Sensors 326 may be positioned at various locations in food transportation box 100 that are suitable for monitoring cavity 108. For example, the temperature sensors and humidity sensors may be deployed at various locations along the wall of cavity 108 (that is, the inner wall of inner shell 104). In some embodiments, sensors 326 may be positioned to monitor different regions of cavity 108. For example, there may be a first temperature sensor positioned to monitor the top third of cavity 108, a second temperature sensor positioned to monitor the middle third of cavity 108, and a third temperature sensor positioned to monitor the bottom third of cavity 108. In some embodiments, sensors 326 may further include sensors for detecting closure and securing of lid 106.

Camera 328 may be located in inner shell 104 and oriented to capture images of cavity 108. Images from camera may be output to output device 324 or client device 340. In some embodiments, camera 328 may be used to capture images of codes associated with food held in cavity 108 (e.g., barcodes, QR codes) and provide those images to computing system 110.

Computing system 110 may be coupled to temperature manipulation elements and humidity manipulation elements in food transportation box 100 via I/O devices interface 306. For example, food transportation box 100 may include one or more heating elements 332, one or more fans 334, a vent system 336, and a humidity system 338.

Heating elements 332 generates heat for cavity 108. Heating elements 332 convert electricity (e.g., from power source 318) into heat directed into cavity 108. Heating elements 332 may be positioned to heat various regions of cavity 108. Heating elements 332 are communicatively coupled to computing system 110 via I/O devices interface 306. Computing system 110 may control heating elements 332 to heat cavity 108 or one or more regions thereof.

Fans 334 manipulate airflow in cavity 108. By manipulating the airflow via fans 334, heat may be circulated within cavity 108 and/or humidity may be controlled within cavity 108. Fans 334 may include air circulation fans or air intake/exhaust fans. Air intake/exhaust fans may be positioned at a vent (e.g., vent 204). Fans 334 are communicatively coupled to computing system 110 via I/O devices interface 306. Computing system 110 may control fans 334 to manipulate airflow within cavity 108 and/or airflow into or out of cavity 108, thereby controlling the temperature and/or humidity in cavity 108.

Vent system 336 allows air to flow in or out of cavity 108. Vent system 336 includes vent openings (e.g., vent 204) that allow air to flow in or out, and also optionally includes one or more vent shutters. A vent shutter is positioned at a vent opening and is communicatively coupled to computing system 110 via I/O devices interface 306. Computing system 110 may control a vent shutter to open or shut a corresponding vent opening, which manipulates airflow into or out of cavity 108, thereby controlling the temperature and/or humidity in cavity 108.

Humidity system 338 manipulates the humidity of cavity 108. In some embodiments, humidity system 338 includes fans 334 and/or vent system 336; humidity system 338 manipulates humidity by exhausting more humid air out of cavity 108 and/or drawing less humid air into cavity 108. In some embodiments, humidity system 338 may manipulate humidity by introducing moisture into cavity 108. For example, in embodiments where outer shell 102 includes a refillable water chamber, humidity system 338 may draw water from the water chamber and introduce the water (e.g., by spraying, by misting, by evaporation) into cavity 108. More generally, humidity system 338 may manipulate the humidity (e.g., humidifying and/or dehumidifying) of cavity 108 using any technically feasible technique. For example, humidity may be increased (humidification) by drawing in humid air from the exterior into cavity 108, adding moisture from a water chamber of food transportation box 100 (e.g., using a nebulizer or a mister). For example, humidity may be decreased (dehumidification) by venting cavity 108, using a desiccant (e.g., exposing the desiccant to cavity 108), or using a moisture scavenging system.

Power source 318 supplies electrical power to computing system 110 and other components of food transportation box 100 that requires electrical power for operation (e.g., heating elements 332, fans 334, vent shutters of vent system 336, humidity system 338, camera 328, sensors 326, etc.). In various embodiments, power source 318 may include a battery. The battery may be removable or non-removable from food transportation box 100, and may be rechargeable or non-rechargeable. In some embodiments, the battery may be rechargeable while in food transportation box 100 (e.g., when food transportation box 100 is plugged into a wall power socket or vehicle auxiliary power outlet). In some embodiments, the battery may be removed and placed in a battery charging dock or station for recharging. Power source 318 may also include a power supply that may be electrically coupled to an external power source (e.g., external battery, wall power socket, auxiliary power outlet in a vehicle, USB plug of client device 340) via wire or cable to charge the battery and/or supply electrical power to computing system 110 and other components of food transportation box 100. Delivery of power from power source 318 to the components may be regulated by computing system 110 based on operational needs of the components. For example, computing system 110 may reduce power to output devices 324 (e.g., a display) after a idleness timeout to prolong battery life.

Client device 340 is a computing device that may be communicatively coupled to computing system 110. Client device 340 may be a portable device (e.g., a smartphone, a tablet computer), a laptop computer, or a desktop computer, or any other suitable computing device. Client device 340 may be communicatively coupled to computing system 110 via network 350 (e.g., via a Wi-Fi network, via a local Bluetooth connection) or via I/O devices interface 306 (e.g., via USB over a cable). Client device 340 may include an application (or “app”) 342 that communicates with computing system 110. App 342 includes functionality (e.g., a user interface, protocols for communicating with computing system 110, commands for activating various functions at computing system 110 and/or food transportation box 100, etc.) for configuring computing system 110 and monitoring food transportation box 100. For example, a user may use app 342 to create and/or update a database of temperature and humidity setpoints for different types of foods for storage in storage 304, to configure the desired temperature and humidity setpoints for a given food delivery trip, or to run diagnostics on computing system 110. A user may also use the application to review images from camera 328 and/or to review data from sensors 326 (e.g., to monitor the current temperature and humidity levels of cavity 108). Accordingly, client device 340, with app 342, may be a supplement or replacement for input devices 322 and output devices 324.

Storage 304 stores one or more databases 316. Databases 316 or portions thereof (e.g., individual records) may be loaded into memory 312 during operation of computing system 110. Databases 316 may include a database that maps types of foods to respective temperature and humidity setpoints, and optionally to other setpoints (e.g., oxygen or carbon dioxide level setpoints). For example, the database may include a record that specifies temperature and humidity setpoints for french fries, and another record that specifies temperature and humidity setpoints for french onion soup. The database may also map codes (e.g., barcodes, QR codes) to the different food types. Databases 316 may also store data corresponding to programs for various functions (e.g., temperature and time for a self-cleaning function). Databases 316 may be viewed, created, and updated at food transportation box 100 via input devices 322 and output devices 324, or via app 342 on client device 340. And although the one or more databases 316 are shown as part of computing system 110, one or more of them may be located remotely to computing system 110 and accessible through the one or more networks 350 and/or client device 340.

Memory 312 may include a food environment control application 314. Food environment control application 314 may be stored in and loaded from storage 304. In operation, for a given food delivery run, the user first powers on food transportation box 100. After food transportation box 100 has powered on, food environment control application 314 may receive one or more inputs setting at least a temperature setpoint and a humidity setpoint for the food delivery run. In various embodiments, a user may manually input the temperature and humidity setpoint values into computing system 110 (e.g., via input device 322). The temperature setpoint may be expressed as temperature value (in Fahrenheit or Celsius), and the humidity value may be expressed as a percentage or relative humidity. For example, the user may input a temperature setpoint of 190 degrees Fahrenheit and a humidity setpoint of 25%. In some embodiments, the user may input a type of food to be held in cavity 108. Food environment control application 314 looks up the temperature and humidity setpoints corresponding to the type of food in the one or more databases 316 and sets the temperature and humidity setpoints accordingly. The user may input the type of food manually (e.g., a keypad, via client device 340) or by scanning a code that encodes the type of food (e.g., via a scanner on food transportation box 100, via a camera of client device 340). The code may be printed on a receipt, order list, or the like accompanying the food. In some embodiments, camera 328 may capture the code while the food and the receipt are held in cavity 108.

After the temperature and the humidity setpoints are set, food environment control application 314 may first detect whether lid 106 is closed and secured via sensors 326 and/or camera 328. If food environment control application 314 determines that lid 106 is not closed or secured, then food environment control application 314 may output an alert or notification to output devices 324 or client device 340 indicating that lid 106 is not closed and that the user should close and secure lid 106. After a determination that lid 106 is closed and secured, food environment control application 314 may activate the temperature manipulation elements and/or humidity manipulation elements at manipulation levels to actively manipulate the temperature (e.g., heat) of cavity 108 and/or to actively manipulate (e.g., increase or decrease) the humidity level of cavity 108, in order to prepare (e.g., preheat) cavity 108 for food to be held in cavity 108. For example, food environment control application 314 activates heating elements 332 to heat cavity 108 up to the temperature setpoint, and/or activates humidity system 228 to humidify or dehumidify cavity 108 to the humidity setpoint. In some embodiments, food environment control application 314 may determine the current temperature and humidity levels to determine how much to heat cavity 108 and/or how far to change the humidity level of cavity 108 to prepare cavity 108, and to activate the temperature manipulation elements and humidity manipulation elements accordingly. Concurrently, food environment control application 314 receives data from sensors 326 and monitors the temperature and humidity levels, and optionally additional parameters, in cavity 108. Food environment control application 314 may get readings data from sensors 326 periodically (e.g., every second, every 5 seconds, every half minute). When the temperature level or humidity level has reached the respective setpoint (e.g., within a predefined tolerance), food environment control application 314 may keep the temperature manipulation elements and the humidity manipulation elements, respectively, activated at a maintenance level (e.g., at a power level that is just enough to maintain temperature and humidity at the setpoint levels). In some embodiments, as the temperature and/or humidity level gets closer to the corresponding setpoint, food environment control application 314 may adjust the temperature manipulation elements and/or the humidity manipulation elements (e.g., ease up on the heat generated by heating elements 332) to ease the transition of the temperature and/or humidity levels to the respective setpoints, or to maintain one of the temperature level or humidity level at the corresponding setpoint while the other level catches up.

Food environment control application 314 may determine, based on the data from sensors 326, that the temperature and humidity levels in cavity 108 has reached the setpoints (e.g., within a predefined tolerance). In response, food environment control application 314 may output an alert or notification to output devices 324 or client device 340 indicating that cavity 108 is ready for placement of the food. The user may open lid 106 to place the food in cavity 108 and then close lid 106.

After the food is placed in cavity 108, food environment control application 314 may detect whether lid 106 is closed and secured via sensors 326 and/or camera 328. If food environment control application 314 determines that lid 106 is not closed or secured, then food environment control application 314 may output an alert or notification to output devices 324 or client device 340 indicating that lid 106 is not closed and that the user should close and secure lid 106.

After a determination that lid 106 is closed and secured, food environment control application 314 receives data from sensors 326 and monitors the temperature and humidity levels, and optionally additional parameters, in cavity 108, similar to the monitoring during preparation of cavity 108 described above. If, based on the monitoring, food environment control application 314 determines that the temperature level and/or the humidity level have not met the setpoints, food environment control application 314 may activate the temperature manipulation elements and/or humidity manipulation elements to heat or cool cavity 108 and/or to change the humidity level of cavity 108 until the temperature level and the humidity level meet the setpoint levels. When food environment control application 314 determines that the temperature level and the humidity level has met the setpoints, food environment control application 314 may keep the temperature manipulation elements and/or the humidity manipulation elements activated at a maintenance level (e.g., at a power level that is just enough to maintain temperature and humidity at the setpoint levels). If the temperature and/or humidity levels change to levels that are not within the tolerance of the setpoint (e.g., the user had opened lid 106 causing the temperature in cavity 108 to drop), food environment control application 314 may activate the temperature manipulation elements and/or the humidity manipulation elements at active levels to return the temperature and humidity levels to the setpoints. Food environment control application 314 may continue this cycle of monitoring and activating temperature manipulation elements and/or the humidity manipulation elements (at active levels or maintenance levels) until the food is delivered to the customer and the user powers down food transportation box 100.

In some embodiments, food environment control application 314 may monitor and manipulate additional parameters in addition to temperature and humidity. For example, food environment control application 314 receive input of oxygen and/or carbon dioxide setpoints, and may monitor the oxygen and/or carbon dioxide levels in cavity 108. Food environment control application 314 may activate fans 334 and/or vent system 336 to manipulate the airflow in and out of cavity until the oxygen and/or carbon dioxide levels meets the setpoints.

In some embodiments, food environment control application 314 may monitor, control, and manipulate temperature and humidity levels locally per region of cavity 108. For example, returning to FIG. 2, food environment control application 314 may monitor the temperature and humidity levels of the top, middle, and bottom regions, as represented by the three racks 202. Food environment control application 314 may also receive temperature and humidity setpoints per region (e.g., via manual input by the user, via input of different food types per region by the user). If food environment control application 314 detects that the temperature and humidity levels for a region does not meet the setpoints for that region, food environment control application 314 may activate a subset of the temperature manipulation elements and the humidity manipulation elements, or activate the elements at different power levels, to return that region back to the setpoints while minimizing the effect on the other regions.

In some embodiments, food transportation box 100 may hold food for multiple customer orders at once, or may hold multiple foods with different temperature and humidity setpoints for one customer order. In these embodiments, if food environment control application 314 receives input of the different food types being held, then food environment control application 314 may automatically adjust the temperature and humidity setpoints to ensure that quality for all of the foods held in cavity 108 are preserved to some extent (as opposed to, for example, setting temperature and humidity setpoints to optimize one food type while ruining the quality of the other food types in cavity 108). Alternatively, different types of foods may be held in different regions of cavity 108, and the temperature and humidity levels may be monitored, controlled, and manipulated locally per region, as described above.

In some embodiments, food environment control application 314 and/or app 342 may, based on the food types in cavity 108, indicate to the user that one or more of the foods held in cavity 108 has a more sensitive food quality (e.g., are more prone to decay in quality). For example, if cavity 108 is holding crispy fried chicken and a soup, food environment control application 314 or app 342 may output a notification informing the user that the quality of the crispy fried chicken is more sensitive, particularly the texture. With this information, the user may plan the delivery route accordingly to minimize delivery time for the sensitive food.

In operation, food environment control application 314 may output various information to output devices 324 and/or client device 340 for presentation to a user. For example, food environment control application 314 may output the current temperature in cavity 108 (e.g., in Fahrenheit or Celsius) based on data from sensors 326, the current humidity level in cavity 108 (e.g., as a percentage or relative humidity) based on data from sensors 326, the temperature setpoint, and the humidity setpoint. These values may be output (e.g., displayed on a display of output devices 324 or in app 342) concurrently or in a sequence (e.g., one at a time in a cycle). Other information that may be output by food environment control application 314 to output devices 324 and/or client device 340 include, without limitation, types of food that are held in cavity 108 (e.g., as input by the user and which may be updated as food deliveries are made), a battery life of a battery of power source 318, a battery charging status of the battery, error or danger alerts (e.g., alert that lid 106 is not closed and secured, alert that heating elements 332 are overheating), and/or the like.

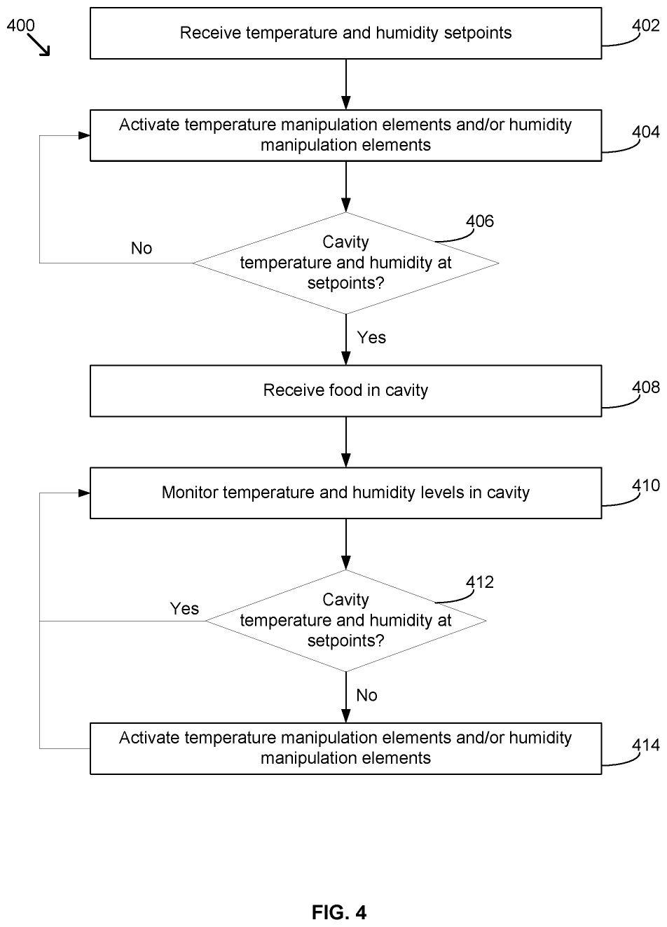

FIG. 4 illustrates a flow diagram showing method steps for controlling a food transportation environment, in accordance with various embodiments. Although the method steps are described in conjunction with the systems of FIGS. 1A-3, persons skilled in the art will understand that any system configured to perform the method steps, in any order, falls within the scope of the various embodiments.

A method 400 begins at step 402, where food environment control application 314 receives temperature and humidity setpoints. Food environment control application 314 may receive the setpoints for a given delivery of food via manual input by the user, or from database 316 after receiving user input of one or more food types to be held in cavity 108 and looking up the food types in database 316.

At step 404, food environment control application 314 activates temperature manipulation elements and/or humidity manipulation elements to prepare cavity 108 for the food. In particular, food environment control application 314 activates temperature manipulation elements and/or humidity manipulation elements to manipulate the temperature and humidity levels in cavity 108 until the levels meet the setpoints.

At step 406, food environment control application 314 determines whether the temperature and the humidity levels in cavity 108 have met the setpoints or not. Food environment control application 314 may make the determination based on data from sensors 326. If food environment control application 314 determines that the temperature or the humidity levels in cavity 108 do not meet the setpoints, then method 400 returns to step 404, where food environment control application 314 continues to activate temperature manipulation elements and/or humidity manipulation elements. In some embodiments, food environment control application 314 may verify that lid 106 is closed and secured before activating temperature manipulation elements and/or humidity manipulation elements to prepare cavity 108 for the food.

If food environment control application 314 determines that the temperature and the humidity levels in cavity 108 have met the setpoints, then method 400 proceeds to step 408, where cavity 108 may receive the food. In particular, the user opens lid 106 to put the food into cavity 108, then closes and secures lid 106. Food environment control application 314 may verify that lid 106 is closed and secured, and notify the user if lid 106 is not closed and secured.

At step 410, food environment control application 314 monitors the temperature and the humidity levels in cavity 108. Food environment control application 314 periodically obtain sensor data from sensors 326 and determine the current temperature and humidity levels based on the sensor data. Also, at step 410, food environment control application 314 may activate the temperature manipulation elements and humidity manipulation elements at maintenance levels.

At step 412, food environment control application 314 determines whether the temperature and the humidity levels in cavity 108 have met the setpoints or not, based on the data from sensors 326. If food environment control application 314 determines that the temperature or the humidity levels in cavity 108 do not meet (e.g., have deviated from) the setpoints, then method 400 proceeds to step 414, where food environment control application 314 activates temperature manipulation elements and/or humidity manipulation elements. In particular, food environment control application 314 activates the temperature manipulation elements and/or humidity manipulation elements to manipulate the temperature and/or humidity levels in cavity 108 until the levels meet the setpoints.

If food environment control application 314 determines that the temperature and the humidity levels in cavity 108 meet the setpoints, then method 400 returns to step 412, where food environment control application 314 continues to monitor the temperature and the humidity levels in cavity 108 and activate the temperature manipulation elements and humidity manipulation elements at maintenance levels. The cycle between steps 410, 412 and 414 may continue until the user deactivates food transportation box 100 (e.g., the user powers down food transportation box 100).

In sum, a food transportation system controls and/or maintains temperature and humidity within a food-holding environment. A food transportation system includes a box or container with a cavity in which food is placed. The box also includes sensors for monitoring temperature and humidity in the cavity. The box also includes temperature manipulation elements and humidity manipulation elements, examples of which include heating elements for heating the interior of the cavity, fans for controlling airflow within and out of the cavity, vents for allowing airflow in or out, sensors for monitoring temperature and humidity within the cavity, and a humidification and/or dehumidification system for introducing moisture into and/or removing moisture from the cavity. The box also includes a control system with a processor that processes data from the sensors and, based on the sensor data, controls the temperature manipulation elements and humidity manipulation elements to maintain temperature and/or humidity levels within the cavity at respective setpoints. The temperature and/or humidity setpoints may be set directly or set based on the type(s) of food held in the cavity.

An advantage and technological improvement of the disclosed techniques is that both temperature and humidity are actively controlled and maintained within an environment in which food is held for transportation. Accordingly, food quality can be better preserved door-to-door in comparison to conventional techniques. Another advantage and technological improvement is that the temperature and humidity control can account for the temperature and humidity needs of different types of foods. Accordingly, food quality can be better preserved across a variety of different foods.

1. In some embodiments, a food transportation system comprises a box comprising a cavity; a plurality of sensors, the plurality of sensors comprising a temperature sensor and a humidity sensor; one or more temperature manipulation elements; one or more humidity manipulation elements; memory; and a processor that is coupled to the memory and, when executing one or more instructions stored in the memory, is configured to monitor a temperature within the cavity via the temperature sensor; determine, based on data from the temperature sensor, whether the temperature within the cavity meets a temperature setpoint; control the temperature within the cavity via the one or more temperature manipulation elements to meet the temperature setpoint; monitor a humidity within the cavity via the humidity sensor; determine, based on data from the humidity sensor, whether the humidity within the cavity meets a humidity setpoint; and control the humidity within the cavity via the one or more humidity manipulation elements to meet the humidity setpoint.

2. The system of clause 1, wherein controlling the temperature within the cavity comprises at least one of: heating the cavity, circulating air within the cavity, exhausting air from the cavity, or drawing air into the cavity.

3. The system of clauses 1 or 2, wherein controlling the humidity within the cavity comprises at least one of: humidifying the cavity or dehumidifying the cavity.

4. The system of any of clauses1-3, wherein the one or more temperature manipulation elements comprises one or more heating elements.

5. The system of any of clauses1-4, wherein the one or more temperature manipulation elements comprises at least one of: one or more fans or one or more vents.

6. The system of any of clauses1-5, wherein the one or more humidity manipulation elements comprises at least one of: one or more fans or one or more vents.

7. The system of any of clauses1-6, wherein the one or more humidity manipulation elements comprises at least one of: a dehumidifier, or a humidifier.

8. The system of any of clauses1-7, wherein the processor, when executing the one or more instructions, is further configured to receive input setting the temperature setpoint and the humidity setpoint.

9. The system of any of clauses1-8, further comprising a user interface, wherein the input setting the temperature setpoint and the humidity setpoint is received via the user interface.

10. The system of any of clauses1-9, wherein the input comprises input specifying a type of food, and the type of food is associated with the temperature setpoint and humidity setpoint.

11. The system of any of clauses1-10, wherein the input setting the temperature setpoint and the humidity setpoint is received from an application in a client device external to the box.

12. In some embodiments, a container for transporting food comprises a cavity; a plurality of sensors, the plurality of sensors comprising a temperature sensor and a humidity sensor; one or more temperature manipulation elements; one or more humidity manipulation elements; memory; and a processor that is coupled to the memory and, when executing one or more instructions stored in the memory, is configured to monitor a temperature within the cavity via the temperature sensor; determine, based on data from the temperature sensor, whether the temperature within the cavity meets a temperature setpoint; control the temperature within the cavity via the one or more temperature manipulation elements to meet the temperature setpoint; monitor a humidity within the cavity via the humidity sensor; determine, based on data from the humidity sensor, whether the humidity within the cavity meets a humidity setpoint; and control the humidity within the cavity via the one or more humidity manipulation elements to meet the humidity setpoint.

13. The container of clause 12, wherein controlling the temperature within the cavity comprises at least one of: heating the cavity, circulating air within the cavity, exhausting air from the cavity, or drawing air into the cavity.

14. The container of clauses 12 or 13, wherein controlling the humidity within the cavity comprises at least one of: humidifying the cavity or dehumidifying the cavity.

15. The container of any of clauses 12-14, wherein the processor, when executing the one or more instructions, is further configured to receive input setting the temperature setpoint and the humidity setpoint.

16. The container of any of clauses 12-15, wherein the input comprises input specifying a type of food, and the type of food is associated with the temperature setpoint and humidity setpoint.

17. In some embodiments, a computer-implemented method for maintaining food quality during transportation comprises monitoring a temperature within a cavity of a container via a temperature sensor; determine, based on data from the temperature sensor, whether the temperature within the cavity meets a temperature setpoint; control the temperature within the cavity via one or more temperature manipulation elements to meet the temperature setpoint; monitor a humidity within the cavity via a humidity sensor; determine, based on data from the humidity sensor, whether the humidity within the cavity meets a humidity setpoint; and control the humidity within the cavity via one or more humidity manipulation elements to meet the humidity setpoint.

18. The method of clause 17, wherein controlling the temperature within the cavity comprises at least one of: heating the cavity, circulating air within the cavity, exhausting air from the cavity, or drawing air into the cavity.

19. The method of clauses 17 or 18, wherein controlling the humidity within the cavity comprises at least one of: humidifying the cavity or dehumidifying the cavity.

20. The method of any of clauses 17-19, further comprising receiving input setting the temperature setpoint and the humidity setpoint.

Any and all combinations of any of the claim elements recited in any of the claims and/or any elements described in this application, in any fashion, fall within the contemplated scope of the present protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A food transportation system, comprising:
a box comprising a cavity;
a plurality of sensors, the plurality of sensors comprising a temperature sensor and a humidity sensor;
one or more temperature manipulation elements;
one or more humidity manipulation elements;
memory; and
a processor that is coupled to the memory and, when executing one or more instructions stored in the memory, is configured to:
monitor a temperature within the cavity via the temperature sensor;
determine, based on data from the temperature sensor, whether the temperature within the cavity meets a temperature setpoint;
control the temperature within the cavity via the one or more temperature manipulation elements to meet the temperature setpoint;
monitor a humidity within the cavity via the humidity sensor;
determine, based on data from the humidity sensor, whether the humidity within the cavity meets a humidity setpoint; and
control the humidity within the cavity via the one or more humidity manipulation elements to meet the humidity setpoint.

2. The system of claim 1, wherein controlling the temperature within the cavity comprises at least one of: heating the cavity, circulating air within the cavity, exhausting air from the cavity, or drawing air into the cavity.

3. The system of claim 1, wherein controlling the humidity within the cavity comprises at least one of: humidifying the cavity or dehumidifying the cavity.

4. The system of claim 1, wherein the one or more temperature manipulation elements comprises one or more heating elements.

5. The system of claim 1, wherein the one or more temperature manipulation elements comprises at least one of: one or more fans or one or more vents.

6. The system of claim 1, wherein the one or more humidity manipulation elements comprises at least one of: one or more fans or one or more vents.

7. The system of claim 1, wherein the one or more humidity manipulation elements comprises at least one of: a dehumidifier, or a humidifier.

8. The system of claim 1, wherein the processor, when executing the one or more instructions, is further configured to receive input setting the temperature setpoint and the humidity setpoint.

9. The system of claim 8, further comprising a user interface, wherein the input setting the temperature setpoint and the humidity setpoint is received via the user interface.

10. The system of claim 8, wherein the input comprises input specifying a type of food, and the type of food is associated with the temperature setpoint and humidity setpoint.

11. The system of claim 8, wherein the input setting the temperature setpoint and the humidity setpoint is received from an application in a client device external to the box.

12. A container for transporting food, comprising:
a cavity;
a plurality of sensors, the plurality of sensors comprising a temperature sensor and a humidity sensor;
one or more temperature manipulation elements;
one or more humidity manipulation elements;
memory; and
a processor that is coupled to the memory and, when executing one or more instructions stored in the memory, is configured to:
monitor a temperature within the cavity via the temperature sensor;
determine, based on data from the temperature sensor, whether the temperature within the cavity meets a temperature setpoint;
control the temperature within the cavity via the one or more temperature manipulation elements to meet the temperature setpoint;
monitor a humidity within the cavity via the humidity sensor;
determine, based on data from the humidity sensor, whether the humidity within the cavity meets a humidity setpoint; and
control the humidity within the cavity via the one or more humidity manipulation elements to meet the humidity setpoint.

13. The container of claim 12, wherein controlling the temperature within the cavity comprises at least one of: heating the cavity, circulating air within the cavity, exhausting air from the cavity, or drawing air into the cavity.

14. The container of claim 12, wherein controlling the humidity within the cavity comprises at least one of: humidifying the cavity or dehumidifying the cavity.

15. The container of claim 12, wherein the processor, when executing the one or more instructions, is further configured to receive input setting the temperature setpoint and the humidity setpoint.

16. The container of claim 15, wherein the input comprises input specifying a type of food, and the type of food is associated with the temperature setpoint and humidity setpoint.

17. A computer-implemented method for maintaining food quality during transportation, comprising:
monitoring a temperature within a cavity of a container via a temperature sensor;
determine, based on data from the temperature sensor, whether the temperature within the cavity meets a temperature setpoint;
control the temperature within the cavity via one or more temperature manipulation elements to meet the temperature setpoint;
monitor a humidity within the cavity via a humidity sensor;
determine, based on data from the humidity sensor, whether the humidity within the cavity meets a humidity setpoint; and
control the humidity within the cavity via one or more humidity manipulation elements to meet the humidity setpoint.

18. The method of claim 17, wherein controlling the temperature within the cavity comprises at least one of: heating the cavity, circulating air within the cavity, exhausting air from the cavity, or drawing air into the cavity.

19. The method of claim 17, wherein controlling the humidity within the cavity comprises at least one of: humidifying the cavity or dehumidifying the cavity.

20. The method of claim 17, further comprising receiving input setting the temperature setpoint and the humidity setpoint.
